(19) United States
(12) Patent Application Publication
(10) Pub. No.: US 2006/0139509 A1
(43) Pub. Date: Jun. 29, 2006

(54) Systems for displaying images involving liquid crystal displays

(76) Inventors: Yi Hui Chang, Hsinchu (TW); Meng Ju Chuang, Hsinchu (TW)

Correspondence Address: Michael Bednarek;Pillsbury Winthrop Shaw Pittman LLP, 1650 Tysons Boulevard, McLean, VA, 22102, US

(21) Appl. No.: 11/316,905

(22) Filed: Dec. 27, 2005

(30) Foreign Application Priority Data
Dec. 29, 2004 (TW) 93221126

(51) Int. Cl. G02F 1/1333

(52) U.S. Cl. 349/58

(57) ABSTRACT

The present invention provides a system including a liquid crystal display module and housing. The liquid crystal display module includes a liquid crystal panel and a frame. The frame has a recess part corresponding to a protrusion part of the housing. The liquid crystal display module connects to the housing by the recess part and protrusion part.

### CLAIM PRIORITY

This Application claims the right of priority based on Taiwan Patent Application No. 093221126 filed on Dec. 29, 2004.

### FIELD OF THE INVENTION

The present invention generally relates to a liquid crystal display device.

### BACKGROUND OF THE INVENTION

The liquid crystal display device traditionally includes a liquid crystal display module within a computer, such as a notebook or a portable computer. The liquid crystal display module traditionally includes a liquid crystal display panel 110 and a frame 100, as shown in FIG. 1. The frame 100 includes a connecting part 120 for the liquid crystal display module to connect to the notebook. The connecting part 120 includes a screw hole 130 for a screw to pass through to allow the connection of the housing of the notebook and the frame of the liquid crystal display module.

FIG. 2 shows a conventional liquid crystal display module fixed to the notebook 200. The frame 100 includes the connecting part 120 and screw holes 130 at four corners. The frame 100 is fixed to the housing 210 of the computer by utilizing screws 150 passing through the screw hole 130. However, this kind of fixing means requires minimum thickness for the frame and the notebook housing 210, and requires minimum area of the frame 100 for forming the connecting part 120. Therefore, the weight of the notebook 200 is heavier.

### SUMMARY OF THE INVENTION

Systems for displaying images are provided. In this regard, an embodiment of such a system comprises a liquid crystal display module and a housing. The liquid crystal display module includes a liquid crystal display panel and a frame. The frame includes a first engagement part. The housing includes a second engagement part for connecting to the first engagement part to fix the liquid crystal display module. The second engagement part of the housing connects to the first engagement part of the liquid crystal display module by engagement, attachment or other suitable means.

The system with a liquid crystal display device includes a liquid crystal display module and a housing. The liquid crystal display module includes a liquid crystal display panel and a frame. The frame includes a first engagement part. The housing includes a second engagement. The liquid crystal display module is fixed to the housing by the connection of the first engagement part and the second engagement part of the housing.

### BRIEF DESCRIPTION OF THE DRAWINGS

The invention will become more fully understood from the detailed description given hereinbelow and the accompanying drawings, given by way of illustration only and thus not intended to be limitative of the invention.

FIG. 1 shows a liquid crystal display device of the prior art;

FIG. 2 shows a liquid crystal display device of the prior art fixed to a computer;

FIGS. 3(a) and 3(b) show two embodiments for the liquid crystal display module of the present invention;

FIG. 4 shows a liquid crystal display device of the present invention;

FIG. 5 is a cross-section view of the first embodiment for the engagement assembly;

FIG. 6 is a cross-section view of the second embodiment for the engagement assembly; and

FIG. 7 is a cross-section view of the third embodiment for the engagement assembly.

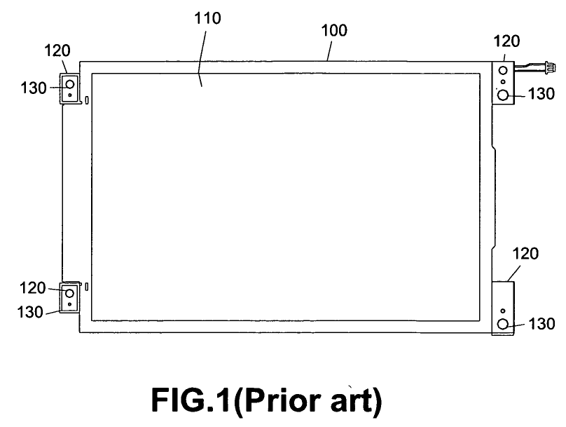

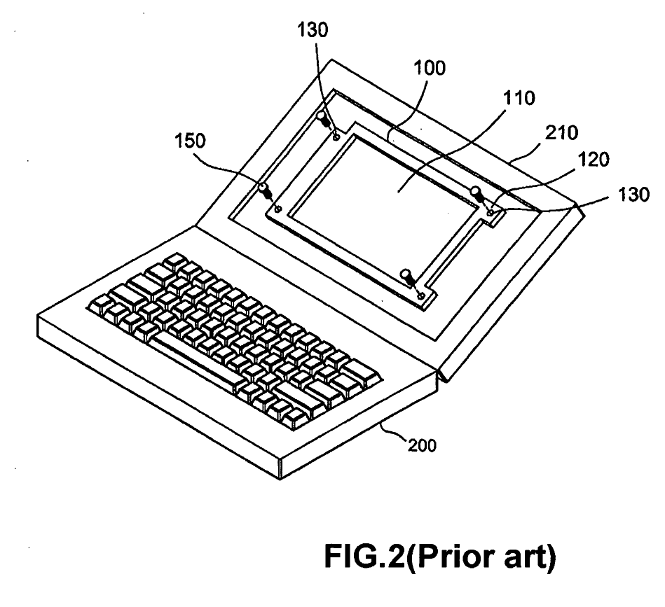

### DETAILED DESCRIPTION

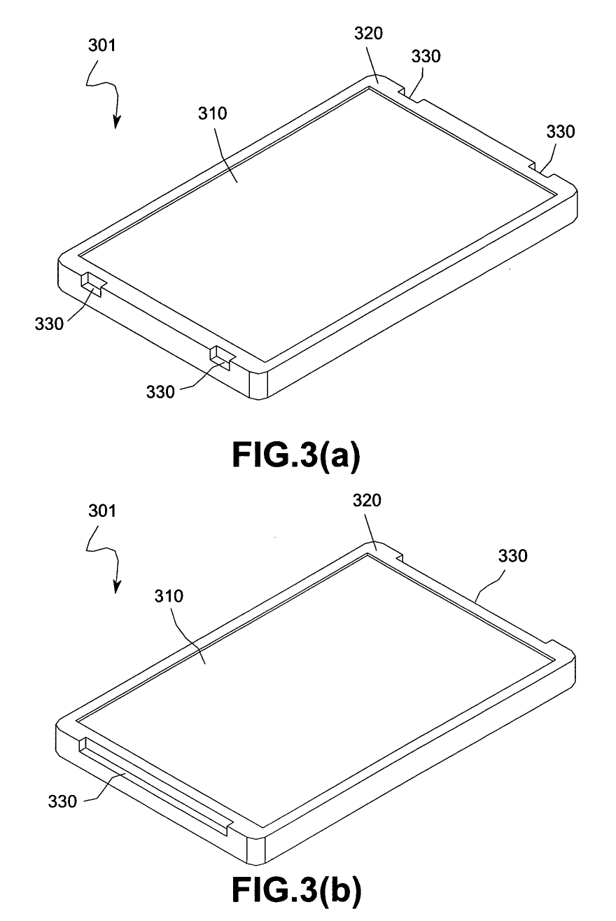

Exemplary embodiments of a system for displaying images will now be described. In this regard, FIGS. 3(a) and 3(b) depict a part of such a system. Specifically, the system incorporates a housing and a liquid crystal display module 301 that includes a liquid crystal display panel 310 and a frame 320. As shown in FIG. 3(a), the frame 320 include two first engagement parts 330 at each of its opposite sides. Alternatively, the frame 320 in FIG. 3(b) includes one first engagement part 330 at each of its opposite sides. In other embodiments, the number of the first engagement part 330 and their positions may be varied to suit a particular designs' choice.

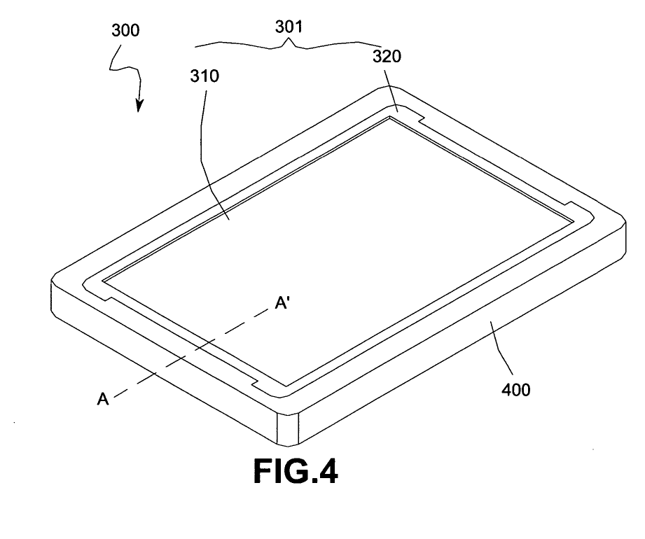

FIG. 4 shows a liquid crystal display device 300 according to an embodiment of the present invention. The liquid crystal display device 300 includes a housing 400 and a liquid crystal display module 301 that includes a liquid crystal display panel 310 and a frame 320. As shown in FIG. 4, the liquid crystal display module 301 is enclosed by the housing 400. That is to say, the housing 400 has an internal part capable of receiving the liquid crystal display module 301. It should be noted that the description herein does not intend to limit the shape of the liquid crystal display device 300 and the manner of the connection between the housing 400 and the liquid crystal display module 301.

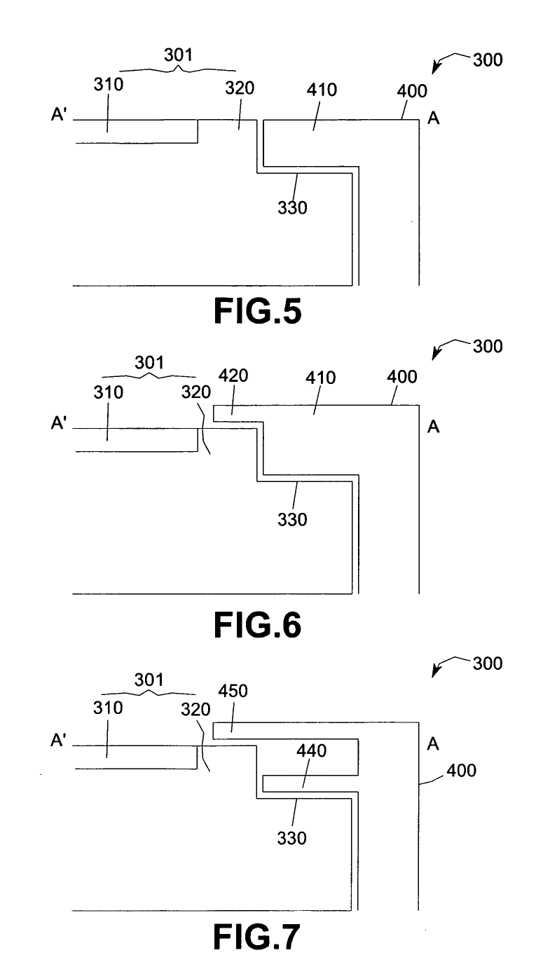

FIG. 5 shows a cross-sectional view taken along line A-A′ of FIG. 4 according to a first embodiment for the engagement assembly. In this embodiment, the liquid crystal display device 300 includes the liquid crystal display module 301 and the housing 400. The liquid crystal display module 301 includes the liquid crystal display panel 310 and the frame 320. The frame 320 includes a first engagement part 330. The housing 400 includes a second engagement part 410, corresponding to the first engagement part 330 for engaging with the first engagement part 330 so as to fix the liquid crystal display module 301. The housing 400 may be a housing for receiving the liquid crystal display module in a notebook. The housing 400 may be made of metal or plastics material. The housing 400 can connect to the rear of the frame 320 by clamp-connection, screw-connection, and the likes known to those skilled in the art, so the details of connection between the housing 400 and the frame 320 are omitted hereinafter. The second engagement part 410 of the housing 400 can be a protrusion connecting to the first engagement part 330 of the liquid crystal display module 301 by engagement, attachment or other suitable means. The first engagement part 330 can be a recess.

FIG. 6 shows a cross-section view of a second embodiment for the engagement assembly. A liquid crystal display device 300 with a liquid crystal display module 301 and a housing 400 is shown in this embodiment. The liquid crystal display module 301 includes a liquid crystal display panel 310 and a frame 320. The frame 320 includes a first engagement part 330. The housing 400 includes a second engagement part 410 and an extension part 420. The second engagement part 410 can be a protrusion of the housing 400 and the extension part 420 may extend from the second engagement part 410. The second engagement part 410 engages with the first engagement part 330, and the extension part 420 covers part of the frame 320 to enhance engagement assembly between the liquid crystal display module 301 and the housing 400.

FIG. 7 shows a cross-section view of a third embodiment for the engagement assembly. Similarly, a liquid crystal display device 300 with a liquid crystal display module 301 and a housing 400 is shown in this embodiment. The liquid crystal display module 301 includes a liquid crystal display panel 310 and a frame 320. The frame 320 includes a first engagement part 330. In this embodiment, the housing 400 includes a third engagement part 450 and a second engagement part 440. The second engagement part 440 engages with the first engagement part 330, and the third engagement part 450 perpendicular to the housing and covers part of the frame 320 to enhance the engagement assembly of the liquid crystal display module 301. Compared with FIG. 6, the housing 400 in FIG. 7 has two separate engagement parts 440, 450. The liquid crystal display module 301 is fixed to the housing 400 by connecting the second engagement part 440 to face to the first engagement part 330 and connecting the third engagement part 450 to face to part of the frame. The method of fixing the liquid crystal display module 301 and the housing 400 can be by engagement, attachment or other suitable means. In this embodiment, the second and third engagement parts 440, 450 can be two protrusions of the housing 400, and have an F-shaped-like structure.

The second engagement part of the housing mentioned above is a protrusion, which corresponds to the first engagement part which is a recess of the liquid crystal display module, and therefore the liquid crystal display module is secured without screws. The shapes of the first engagement part and the second engagement part may be varied to enhance the fixation reliability between the liquid crystal display module and the housing.

By means of the detailed descriptions of what is presently considered to be the most practical and preferred embodiments of the subject invention, it is the expectation that the features and the gist thereof are plainly revealed. Nevertheless, these above-mentioned illustrations are not intended to be construed in a limiting sense. Instead, it should be well understood that any analogous variation and equivalent arrangement is supposed to be covered within the spirit and scope to be protected and that the interpretation of the scope of the subject invention would therefore as much broadly as it could apply.

1. A system for displaying images comprising:
a liquid crystal display module comprising a liquid crystal display panel and a frame, the frame comprising at least a first engagement part; and
a housing enclosing said liquid crystal display module, said housing comprising at least a second engagement part connecting to the first engagement part to fix the liquid crystal display module with the housing.

2. The system of claim 1, wherein the second engagement part is attached to the first engagement part.

3. The system of claim 1, wherein the second engagement part is engaged with the first engagement part.

4. The system of claim 1, wherein the housing comprises metal.

5. The system of claim 1, wherein the housing comprises plastics material.

6. The system of claim 1, wherein the first engagement part comprises a recess.

7. The system of claim 1, wherein the second engagement part comprises a protrusion.

8. A system for displaying images comprising:
a liquid crystal display module comprising a liquid crystal display panel and a frame, the frame comprising at least a first engagement part; and
a housing with an internal part for receiving said liquid crystal display module, said housing comprising at least a second engagement part corresponding to the first engagement part;
wherein the liquid crystal display module is fixed to the housing by the second engagement part and the first engagement part.

9. The system of claim 8, wherein the second engagement part is attached to the first engagement part to fix the liquid crystal display module to the housing.

10. The system of claim 8, wherein the second engagement part is engaged with the first engagement part to fix the liquid crystal display module to the housing.

11. The system of claim 8, wherein the housing comprises metal.

12. The system of claim 8, wherein the housing comprises plastics material.

13. The system of claim 8, wherein the first engagement part comprises a recess.

14. The system of claim 8, wherein the second engagement part comprises a protrusion.

15. The system of claim 8, wherein the second engagement part further comprising an extension part.

16. The system of claim 8, wherein the housing further comprises a third engagement;
wherein the liquid crystal display module is fixed to the housing by connecting the second engagement part face to the first engagement part and connecting the third engagement part face to part of the frame.
